(19) United States
(12) Patent Application Publication
(10) Pub. No.: US 2006/0222259 A1
(43) Pub. Date: Oct. 5, 2006

(54) Information processing apparatus and image processing method

(75) Inventor: Eiki Obara, Hiki-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/392,346

(22) Filed: Mar. 29, 2006

(30) Foreign Application Priority Data
Mar. 30, 2005 (JP) 2005-097899

(51) Int. Cl. G06K 9/40

(52) U.S. Cl. 382/268

(57) ABSTRACT

An information processing apparatus processes image data which is composed of a plurality of blocks. The information processing apparatus includes a determination unit which determines, for each of the blocks, whether a difference value between a maximum pixel value and a minimum pixel value, which belong to the block, is greater than a first threshold value, and a smoothing process unit which executes a smoothing process for eliminating ringing noise for a block in which the difference value is greater than the first threshold value.

### CROSS-REFERENCE TO RELATED APPLICATIONS

This application is based upon and claims the benefit of priority from prior Japanese Patent Application No. 2005-097899, filed Mar. 30, 2005, the entire contents of which are incorporated herein by reference.

### BACKGROUND OF THE INVENTION

1. Field of the Invention

The present invention relates to an information processing apparatus, such as a personal computer, and an image processing method for use in the apparatus.

2. Description of the Related Art

In recent years, personal computers having the same AV functions as audio/video (AV) devices, such as DVD (Digital versatile Disc) players and TV apparatuses, have been developed.

This type of personal computer is required to have a function of decoding and reproducing image data that is compression-encoded by a block encoding system such as MPEG (Moving Picture Expert Group). In the block encoding system such as MPEG, processes of orthogonal transformation, quantization, etc. are executed in units of a block. In this case, a high-frequency component of orthogonal-transformed image data is relatively roughly quantized. Consequently, ringing noise tends to easily occur in the vicinity of an edge part in image data.

As one of techniques for reducing ringing noise, Jpn. Pat. Appln. KOKAI Publication No. 2001-245179 discloses a technique in which an edge is detected on the basis of a difference value between neighboring pixels, and a block including the detected edge is subjected to a smoothing process.

In usual cases, however, in a natural image, a rising edge portion or a falling edge portion of a signal is present over a plurality of pixels. Thus, even if a difference value between neighboring pixels is detected, it is practically difficult to correctly detect all edges. As a result, ringing noise, which is present in the vicinity of a non-detected edge, is not eliminated and is left.

Under the circumstances, in recent years, most of de-ringing process circuits for eliminating ringing noise execute a smoothing process for the entire screen. Thereby, ringing noise can be reduced.

In the meantime, in the case where decoding/reproduction of image data is executed by software in the information processing apparatus such as a personal computer, it is required to reduce as much as possible the amount of arithmetic operations for the de-ringing process.

A conventional de-ringing process, in which the entire screen is subjected to a smoothing process, requires a great deal of arithmetic operations. Thus, it is not practical to apply the conventional de-ringing process to the personal computer.

In addition, if the entire screen is subjected to the smoothing process, minute signals, other than ringing, would be removed, and blurring of the screen would increase.

It is necessary, therefore, to realize a novel technique for implementing a de-ringing process with a small amount of arithmetic operations, without eliminating minute signals other than ringing.

### BRIEF SUMMARY OF THE INVENTION

According to an embodiment of the present invention, there is provided an information processing apparatus which processes image data composed of a plurality of blocks, comprising: a determination unit which determines, for each of the blocks, whether a difference value between a maximum pixel value and a minimum pixel value, which belong to the block, is greater than a first threshold value; and a smoothing process unit which executes a smoothing process for eliminating ringing noise for a block in which the difference value is greater than the first threshold value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view that schematically shows an example of the external appearance of an information processing apparatus according to an embodiment of the present invention;

FIG. 2 is a block diagram that shows an example of the system configuration of the information processing apparatus shown in FIG. 1;

FIG. 3 is a view for explaining an example of the structure of a video reproduction application program that is executed by the information processing apparatus shown in FIG. 1;

FIG. 4 is a view for explaining a first example of a de-ringing process that is executed by the information processing apparatus shown in FIG. 1;

FIG. 5 is a flow chart for illustrating an example of the procedure of the de-ringing process illustrated in FIG. 4;

FIG. 6 is a flow chart for illustrating an example of the procedure for varying a second threshold that is used in the de-ringing process illustrated in FIG. 4;

FIG. 7 is a view for explaining a second example of the de-ringing process that is executed by the information processing apparatus shown in FIG. 1;

FIG. 8 is a flow chart for illustrating an example of the procedure of the de-ringing process illustrated in FIG. 7; and

FIG. 9 is a flow chart for illustrating an example of the procedure for varying a second threshold that is used in the de-ringing process illustrated in FIG. 7.

### DETAILED DESCRIPTION OF THE INVENTION

An embodiment of the present invention will now be described with reference to the accompanying drawings.

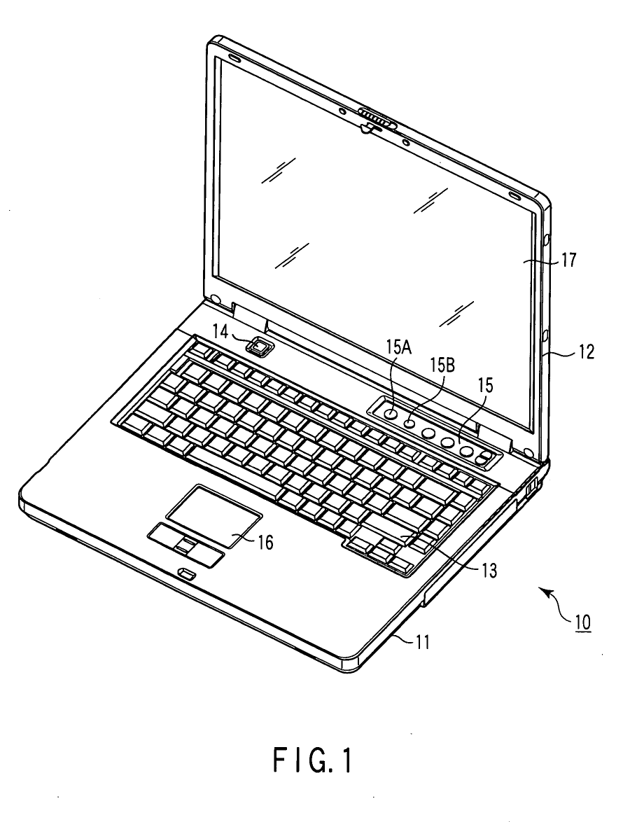

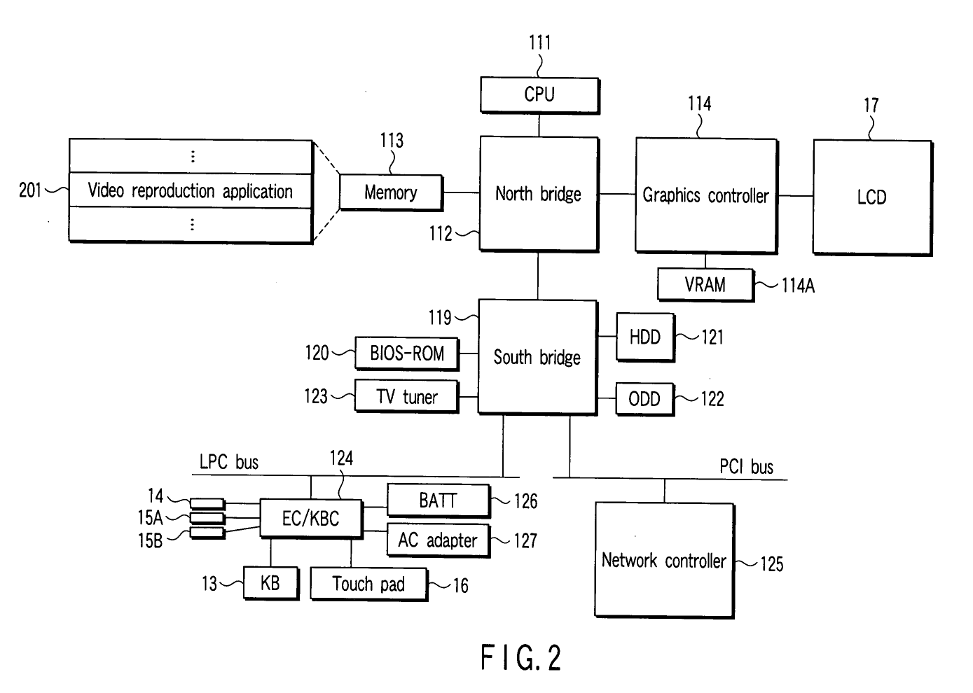

To begin with, referring to FIG. 1 and FIG. 2, an example of the structure of an information processing apparatus according to an embodiment of the invention is described. The information processing apparatus is realized, for example, as a battery-powerable portable notebook personal computer 10.

FIG. 1 is a perspective view that shows the state in which a display unit of the notebook personal computer 10 is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is supported on the computer main body 11 such that the display unit 12 is freely rotatable between an open position where the top surface of the computer main body 11 is exposed and a closed position where the top surface of the computer main body 11 is covered. The computer main body 11 has a thin box-shaped casing. A keyboard 13, a power button 14 for powering on/off the computer 10, an input operation panel 15 and a touch pad 16 are disposed on the top surface of the computer main body 11.

The input operation panel 15 is an input device that inputs an event corresponding to a pressed button. The input operation panel 15 has a plurality of buttons for activating a plurality of functions. The buttons include a TV activation button 15A and a DVD (Digital Versatile Disc) activation button 15B. When the TV activation button 15A is pressed by the user, an application program for executing a TV function is automatically started. The DVD activation button 15B is a button for reproducing video content that is recorded on a DVD. When the DVD activation button 15B is pressed by the user, an application program for reproducing video content is automatically started.

Next, referring to FIG. 2, the system configuration of the computer 10 is described.

The computer 10, as shown in FIG. 2, comprises a CPU 111, a north bridge 112, a main memory 113, a graphics controller 114, a south bridge 119, a BIOS-ROM 120, a hard disk drive (HDD) 121, an optical disc drive (ODD) 122, a TV broadcast tuner 123, an embedded controller/keyboard controller IC (EC/KBC) 124, and a network controller 125.

The CPU 111 is a processor that is provided in order to control the operation of the computer 10. The CPU 111 executes an operating system (OS) and various application programs such as a video reproduction application program 201, which are loaded from the hard disk drive (HDD) 121 into the main memory 113.

The video reproduction application program 201 is a program for reproducing video data, and has a function of decoding digital video data (e.g. broadcast program data that is received and compression-encoded by the TV broadcast tuner 123, MPEG2 video content that is read out of the optical disc drive (ODD) 122, etc.) that is compression-encoded by a block encoding system such as MPEG2.

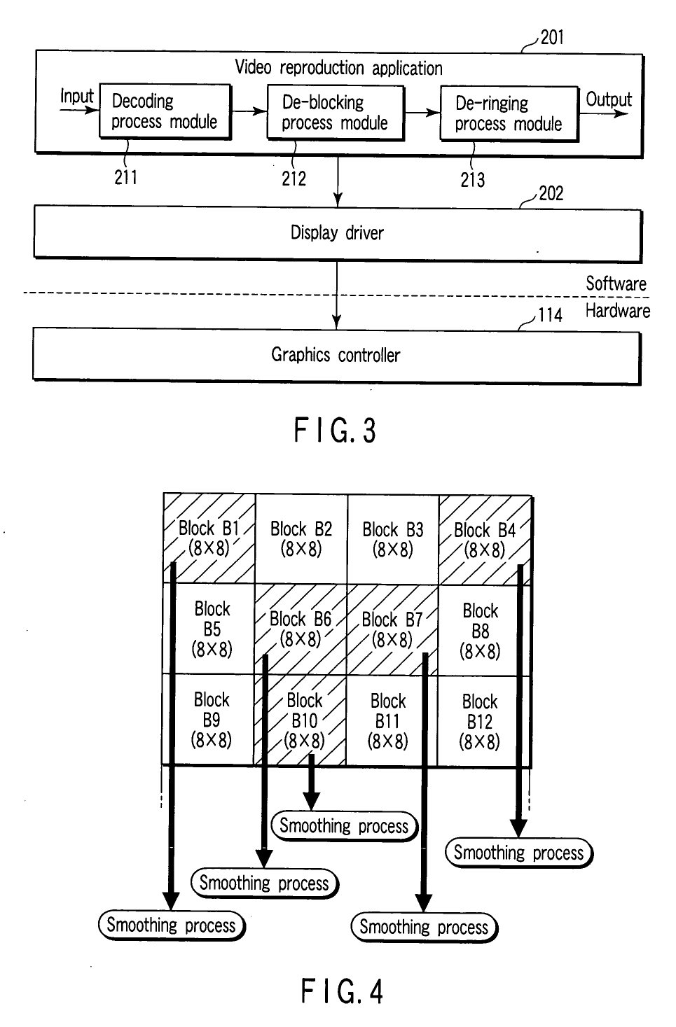

The video reproduction application program 201, as shown in FIG. 3, comprises a decoding process module 211, a de-blocking process module 212 and a de-ringing process module 213.

The decoding process module 211 is a software decoder which decodes motion video data that is compression-encoded by a block encoding system such as MPEG2. The de-blocking process module 212 and de-ringing process module 213 are used to enhance the quality of the decoded motion video data. The de-blocking process module 212 executes a de-blocking process for reducing block noise that is included in the decoded motion video data. The de-ringing process module 213 is a module which executes a de-ringing process for reducing ringing noise that is included in the de-blocked motion video data. The motion video data that has been subjected to the de-ringing process is delivered to the graphics controller 114 via a display driver 202.

The CPU 111 executes the video reproduction application program 201, thereby carrying out the decoding process, de-blocking process and de-ringing process on the memory 113.

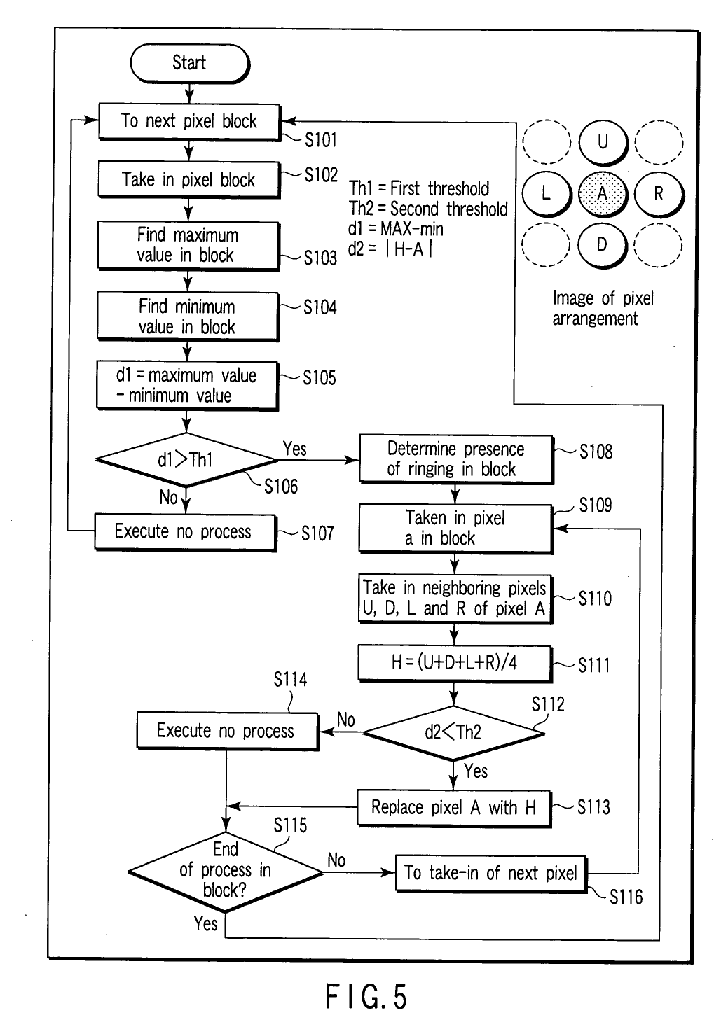

Next, referring to FIG. 4 and FIG. 5, the de-ringing process that is executed by the de-ringing process module 213 is described.

FIG. 4 shows an example of the data structure of decoded motion video data. In the encoding process according to the MPEG2 standard, motion video data is processed in units of a block of, e.g. 8×8 pixels. In the decoding process, too, the compression-encoded motion video data is processed in units of a block of 8×8 pixels. The decoded motion video data includes a plurality of blocks B1 to B12, . . . , each comprising 8×8 pixels.

In the de-ringing process of the present embodiment, the de-ringing process module 213 detects a difference value between a maximum pixel value and a minimum pixel value in each of the blocks on a block-by-block basis. On the basis of the detected difference value, the de-ringing process module 213 determines whether the block may possibly include an edge (a rising edge or falling edge of a signal) which causes ringing noise. A block, in which the difference value between a maximum pixel value and a minimum pixel value exceeds a preset threshold value, is determined to be a block that may possibly include an edge which causes ringing noise. On the other hand, a block, in which the difference value between a maximum pixel value and a minimum pixel value is not greater than the preset threshold value, is determined to be a block that does not include an edge which causes ringing noise. By this determination method, it is possible to detect an edge that is present over more than two pixels. Therefore, it is possible to exactly detect a block that includes an edge which causes ringing noise.

The de-ringing process module 213 executes a smoothing process for eliminating ringing noise for each of the blocks that are determined to possibly include edges. For example, if blocks B1, B4, B6, B7 and B10 of the blocks B1 to B12 are determined to possibly include edges, the de-ringing process module 213 executes the smoothing process for each of the blocks B1, B4, B6, B7 and B10, and does not execute the smoothing process for each of the blocks B2, B3, B5, B8, B9, B11 and B12. Thereby, compared to the conventional de-ringing process in which the entire screen is subjected to the smoothing process, the amount of arithmetic operations necessary for de-ringing can greatly be reduced. Moreover, it is possible to prevent such a situation that minute signals, other than ringing, are eliminated.

Referring to a flow chart of FIG. 5, a description is given of a first example of the procedure of the de-ringing process.

The CPU 111 takes in a block of 8×8 pixels (a pixel block) that is to be processed (step S101, S102). The CPU 111 finds a maximum pixel value (MAX) and a minimum pixel value (min) in the taken-in pixel block (step S103, S104). The CPU 111 calculates a difference value d1 between the maximum pixel value and minimum pixel value (d1=MAX−min) (step S105).

Next, the CPU 111 executes a process for determining whether the calculated difference value d1 is greater than a predetermined first threshold value Th1 (step S106). If the difference value is not greater than the first threshold value Th1 (NO in step S106), the CPU 111 executes no process and returns to step S101, thus beginning a process for the next pixel block. On the other hand, if the difference value is greater than the first threshold value Th1 (YES in step S106), the CPU 111 estimates that a rising signal or a falling signal, which causes ringing noise, is present in the currently processed pixel block, and determines that ringing is present in the pixel block (step S108).

Subsequently, the CPU 111 executes a smoothing process for the pixel block that is determined to include ringing. In the smoothing process, a pixel, in which a difference value between the pixel value of this pixel and the pixel value of a neighboring pixel is less than a predetermined second threshold value Th2, is detected as a pixel that may possibly include ringing, from the pixel block that is determined to include ringing. The pixel value of the detected pixel is corrected so as to reduce the difference between the pixel value of the detected pixel and the pixel value of its neighboring pixel.

A specific procedure of the smoothing process is explained below. Assume that pixels are arranged as shown in FIG. 5. The CPU 111 executes the following process on each of pixels in the pixel block that is determined to include ringing.

The CPU 111 takes in a pixel A and four pixels U, D, R and L, which are located upward, downward, leftward and rightward of the pixel A, from the pixel block that is determined to include ringing (step S109, S110). The CPU 111 calculates a mean value H of the pixel values of the four pixels U, D, R and L (step Sill). The CPU 111 determines whether an absolute value d2 (d2=|H−A|) of the difference between the pixel value of the pixel A and the mean value H is less than a second threshold value Th2 (step S112). If d2 is less than the second threshold value Th2 (YES in step S112), the CPU 111 replaces the pixel value of the pixel A with the mean value H, thus correcting the pixel value of the pixel A (step S113). On the other hand, if d2 is not less than the second threshold value Th2 (NO in step S112), the CPU 111 does not correct the pixel value of the pixel A (step S114).

The process of steps S109 to S114 is repeated until the processing relating to all pixels in the pixel block that is determined to include ringing is completed (step S115).

The second threshold Th2 may be a fixed value. Alternatively, the second threshold Th2 may be varied in accordance with the value d1 of each of the pixel blocks that are determined to include ringing. In this case, the second threshold Th2 is dynamically varied for each of the pixel blocks that are determined to include ringing. The second threshold Th2 can be obtained by multiplying d1 by a predetermined coefficient.

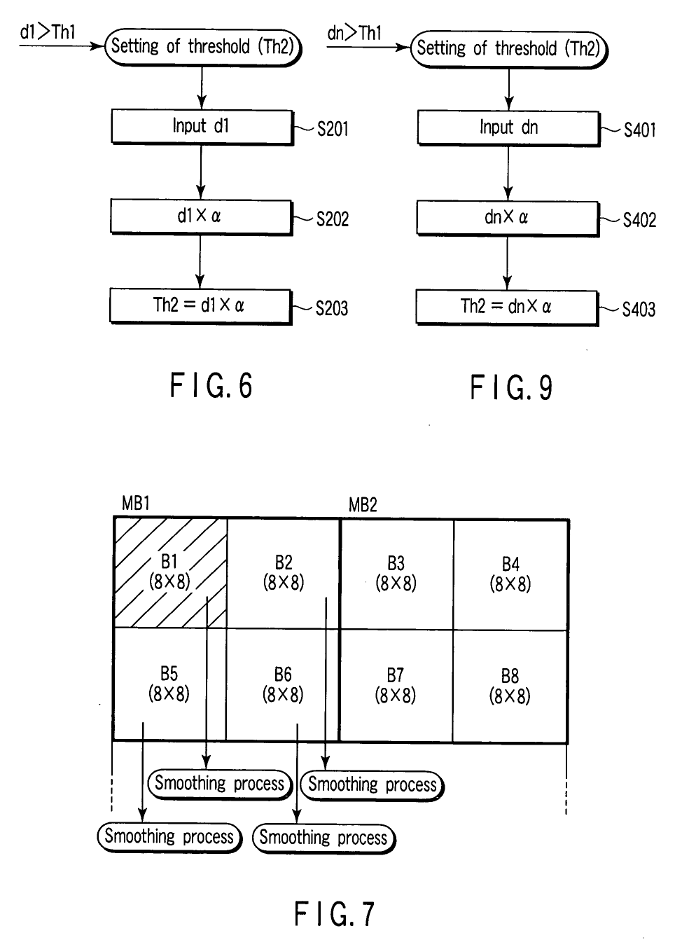

FIG. 6 illustrates the procedure of the process of varying the second threshold Th2. This process is executed, for example, in step S108 in FIG. 5.

The CPU 111 inputs the difference value d1 (step S201), and multiplies it by a constant a (step S202). The CPU 111 sets the multiplication result (d1×α) as the second threshold Th2 (step S203).

It is considered that the pixel block having a greater difference value d1 includes ringing of a higher value. Thus, by varying the second threshold Th2 in accordance with the difference value d1, only ringing noise can more exactly be eliminated.

The smoothing process illustrated in FIG. 5 adopts a comparison method of comparing the pixel value of each pixel with the mean value H of a plurality of pixels (four neighboring pixels) around the pixel, and a correction method of replacing the pixel value of each pixel with the mean value H of the four neighboring pixels. Needless to say, the same advantageous effects can be obtained by other pixel comparison methods and correction methods.

In the above description, the de-ringing process is executed in units of the (8×8) pixel block. However, even if the de-ringing process is executed in units of, e.g. (16×16) macro-block, the same advantageous effects can be obtained. In this case, the CPU 111 first detects a difference value between a maximum pixel value and a minimum pixel value in each of (16×16) macro-blocks, and determines, on the basis of the detected difference value, whether the macro-block is a macro-block which possibly includes an edge (a rising edge or a falling edge) that causes ringing noise. If the difference value between the maximum pixel value and minimum pixel value in the macro-block is greater than a preset threshold, this macro-block is determined to be a macro-block which possibly includes an edge that causes ringing noise. The CPU 111 executes a smoothing process for eliminating ringing noise for each of the macro-blocks that are determined to possibly include edges.

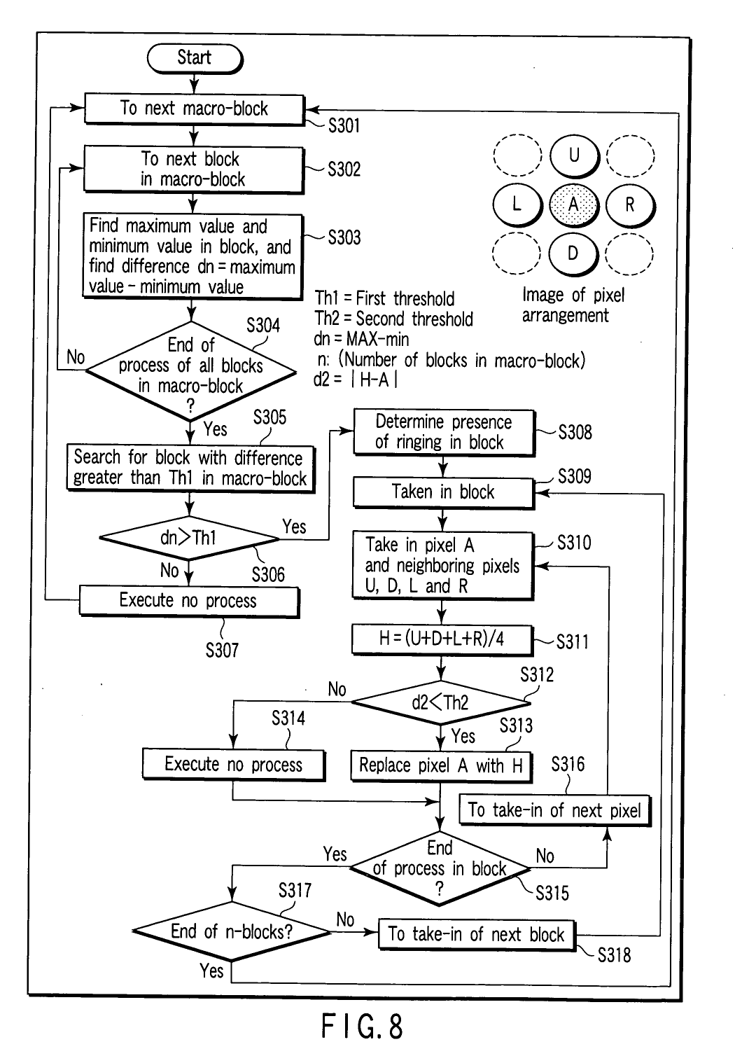

Next, referring to FIG. 7 and FIG. 8, a second example of the de-ringing process that is executed by the de-ringing process module 213 is described.

In usual cases, in the block encoding system such as MPEG2, (8×8) quantization coefficients, which are to be set in a quantization table, are determined in units of a (16×16) macro-block. That is, four (8×8) pixel blocks belonging to the same macro-block are quantized by the same quantization table. Thus, if any one of the four pixel blocks belonging to the same macro-block is determined to include ringing, it is highly probable that the other pixel blocks may also include ringing.

FIG. 7 shows the relationship between a macro-block and pixel blocks. A macro-block MB1 is composed of four pixel blocks B1, B2, B5 and B6 each comprising (8×8) pixels. A macro-block MB2 is composed of four pixel blocks B3, B4, B7 and B8 each comprising (8×8) pixels.

The de-ringing process module 213 detects a difference value between a maximum pixel value and a minimum value in each of the pixel blocks on a block-by-block basis. On the basis of the detected difference value, the de-ringing process module 213 determines whether the pixel block includes ringing. For example, if the pixel block B1 is determined to be a block including ringing, all the pixel blocks B1, B2, B5 and B6 of the macro-block MB1 are subjected to the smoothing process. Thereby, the smoothing process can be executed on all the pixel blocks that are estimated to highly possibly include ringing.

Referring to a flow chart of FIG. 8, a description is given of a specific procedure of the de-ringing process.

The CPU 111 takes in a to-be-processed pixel block from a to-be-processed macro-block (step S301, S302). The CPU 111 finds a maximum pixel value (MAX) and a minimum pixel value (min) in the taken-in pixel block, and calculates a difference value dn between the maximum pixel value (MAX) and the minimum pixel value (min) (dn=MAX−min) (step S303). The process of steps S302 and S303 is repeated until difference values dn in all pixel blocks of the to-be-processed macro-block are calculated.

Next, the CPU 111 determines whether the to-be-processed macro-block includes a pixel block in which the difference value dn is greater than a predetermined first threshold value Th1 (step S305). If there is no such pixel block (NO in step S306), the CPU 111 executes no process and returns to step S301, thus beginning a process for the next macro-block. On the other hand, if there is a pixel block in which the difference value dn is greater than the first threshold value Th1 (YES in step S306), the CPU 111 estimates that a rising signal or a falling signal, which causes ringing noise, is present in the currently processed macro-block, and determines that ringing is present in the macro-block (step S308).

Subsequently, the CPU 111 executes a smoothing process for each pixel block in the macro-block that is determined to include ringing.

Specifically, the CPU 111 takes in the to-be-processed pixel block, and also takes in a pixel A and four pixels U, D, R and L, which are located upward, downward, leftward and rightward of the pixel A, from the pixel block (step S309, S310). The CPU 111 calculates a mean value H of the pixel values of the four pixels U, D, R and L (step S311). The CPU 111 determines whether an absolute value d2 (d2=|H−A|) of the difference between the pixel value of the pixel A and the mean value H is less than a second threshold value Th2 (step S312). If d2 is less than the second threshold value Th2 (YES in step S312), the CPU 111 replaces the pixel value of the pixel A with the mean value H, thus correcting the pixel value of the pixel A (step S313). On the other hand, if d2 is not less than the second threshold value Th2 (NO in step S312), the CPU 111 does not correct the pixel value of the pixel A (step S314).

The process of steps S310 to S314 is repeated until the processing relating to all pixels in the current to-be-processed pixel block is completed (step S315, S316).

If the processing relating to all pixels in the current to-be-processed pixel block is completed (YES in step S315), the CPU 111 advances to step S318 and begins the processing of the next pixel block in the current to-be-processed macro-block.

If the processing relating to all pixel blocks in the current to-be-processed macro-block is completed (YES in step S317), the CPU 111 advances to step S301 and begins the processing of the next macro-block.

In the process of FIG. 8, too, the second threshold Th2 may be varied in accordance with the value d1 of each of the pixel blocks that are determined to include ringing.

FIG. 9 illustrates the procedure of the process of varying the second threshold Th2. This process is executed, for example, in step S308 in FIG. 8.

The CPU 111 inputs the difference value dn (step S401), and multiplies it by a constant a (step S402) The CPU 111 sets the multiplication result (dn×α) as the second threshold Th2 (step S403).

The second threshold Th2 can commonly be used for all the pixel blocks belonging to the same macro-block.

As has been described above, according to the present embodiment, on the basis of a difference between a maximum pixel value and a minimum pixel value in each block (or macro-block), it is determined whether the block is an image that includes ringing. Thus, even in the case of processing image data, such as a natural image, in which an edge may be present over a plurality of pixels, it is possible to exactly detect a block that includes an edge and has a possibility of causing ringing. Thus, the smoothing process can be executed only for the block (or macro-block) including ringing. Thereby, compared to the conventional de-ringing process in which the entire screen is subjected to the smoothing process, the amount of necessary arithmetic operations can greatly be reduced. Moreover, since the block including no ringing is not smoothed, it is possible to prevent such a situation that minute signals, other than ringing, are eliminated.

In the de-ringing process according to the present embodiment, the luminance value of each pixel may be used as the pixel value of each pixel. The invention is applicable not only to motion video data, but also to still image data that is encoded by a block encoding system such as JPEG.

The above-described de-ringing process is all realized by a computer program. Thus, simply by installing this computer program in an ordinary computer via a computer-readable storage medium, the same advantageous effects as in the present embodiment can easily be realized. Needless to say, the above-described de-ringing process may be executed by dedicated hardware.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus capable of processing image data which is composed of a plurality of blocks, comprising:
a determination unit which determines, for each of the blocks, whether a difference value between a maximum pixel value and a minimum pixel value, which belong to the block, is greater than a first threshold value; and
a smoothing process unit which executes a smoothing process for eliminating ringing noise for a block in which the difference value is greater than the first threshold value.

2. The information processing apparatus according to claim 1, wherein the smoothing process unit is configured to detect a pixel in which a difference value between a pixel value of the pixel and a pixel value of a neighboring pixel is less than a second threshold value, from a plurality of pixels included in the block in which the difference value between the maximum pixel value and the minimum pixel value is greater than the first threshold value, and to correct the pixel value of the detected pixel based on the pixel value of the neighboring pixel.

3. The information processing apparatus according to claim 2, further comprising a unit that varies the second threshold value, for each of the blocks in which the difference value between the maximum pixel value and the minimum pixel value is greater than the first threshold value, in accordance with the difference value, which corresponds to each of the blocks, between the maximum pixel value and the minimum pixel value.

4. The information processing apparatus according to claim 1, wherein the image data is composed of a plurality of macro-blocks each including a plurality of pixel blocks,
the determination unit is configured to determine, for each of the pixel blocks, whether a difference value between a maximum pixel value and a minimum pixel value, which belong to the pixel block, is greater than the first threshold value; and
the smoothing process unit executes a smoothing process for eliminating the ringing noise for each of all pixel blocks belonging to a macro-block that includes a pixel block in which the difference value is greater than the first threshold value.

5. The information processing apparatus according to claim 4, wherein the smoothing process unit is configured to detect a pixel in which a difference value between a pixel value of the pixel and a pixel value of a neighboring pixel is less than a second threshold value, from a plurality of pixels included in the pixel block in which the difference value between the maximum pixel value and the minimum pixel value is greater than the first threshold value, and to correct the pixel value of the detected pixel based on the pixel value of the neighboring pixel.

6. The information processing apparatus according to claim 1, wherein each of the blocks is a macro-block.

7. An image processing method which processes image data composed of a plurality of blocks, comprising:
determining, for each of the blocks, whether a difference value between a maximum pixel value and a minimum pixel value, which belong to the block, is greater than a first threshold value; and
executing a smoothing process for eliminating ringing noise for a block in which the difference value is greater than the first threshold value.

8. The image processing method according to claim 7, wherein said executing the smoothing process includes:
detecting a pixel in which a difference value between a pixel value of the pixel and a pixel value of a neighboring pixel is less than a second threshold value, from a plurality of pixels included in the block in which the difference value between the maximum pixel value and the minimum pixel value is greater than the first threshold value; and
correcting the pixel value of the detected pixel based on the pixel value of the neighboring pixel.

9. The image processing method according to claim 8, further comprising varying the second threshold value, for each of the blocks in which the difference value between the maximum pixel value and the minimum pixel value is greater than the first threshold value, in accordance with the difference value, which corresponds to each of the blocks, between the maximum pixel value and the minimum pixel value.

10. The image processing method according to claim 7, wherein the image data is composed of a plurality of macro-blocks each including a plurality of pixel blocks,
the determining includes executing a process of determining for each of the pixel blocks, whether a difference value between a maximum pixel value and a minimum pixel value, which belong to the pixel block, is greater than the first threshold value, and
the executing the smoothing process includes executing a smoothing process for eliminating the ringing noise for each of all pixel blocks belonging to a macro-block that includes a pixel block in which the difference value is greater than the first threshold value.

11. The image processing method according to claim 10, wherein said executing the smoothing process includes:
detecting a pixel in which a difference value between a pixel value of the pixel and a pixel value of a neighboring pixel is less than a second threshold value, from a plurality of pixels included in the pixel block in which the difference value between the maximum pixel value and the minimum pixel value is greater than the first threshold value; and
correcting the pixel value of the detected pixel based on the pixel value of the neighboring pixel.

12. The image processing method according to claim 7, wherein each of the blocks is a macro-block.
